(19) United States
(12) Patent Application Publication
(10) Pub. No.: US 2018/0281241 A1
(43) Pub. Date: Oct. 4, 2018

(54) Curing Device Comprising a Lamp that Produces UV Light

(71) Applicant: I.S.T. Innovative Sewer Technologies GmbH, Bochum (DE)

(72) Inventors: Klaus Schropp, Sulzberg (DE); Jorg Vogt, Bochum (DE); Thomas Reutemann, Bad Hindelang (DE)

(73) Assignee: I.S.T. Innovative Sewer Technologies GmbH, Bochum (DE)

(21) Appl. No.: 15/764,502

(22) PCT Filed: Oct. 10, 2016
(86) PCT No.: PCT/EP2016/074191

§ 371 Date: Mar. 29, 2018

(30) Foreign Application Priority Data
Oct. 8, 2015 (DE) 10 2015 117 206.2

(51) Int. Cl. B29C 35/08; H05B 41/02

(52) U.S. Cl. CPC B29C 35/0805; B29C 2035/0827; H05B 41/02

(57) ABSTRACT

The invention relates to a curing apparatus having at least one UV module (3), wherein the UV module (3) has at least one UV light source (6) for irradiating the inner wall of a pipe (1), wherein the UV module (3) that has been introduced into the pipe (1) is connected, by means of a cable (7), to a control device (9) that is situated outside of the pipe (1). It is an object of the invention to provide a curing apparatus in which the cable (7) for connecting the UV modules (3) to the control device (9) has a cross section that is reduced in comparison with the prior art. As a result, longer pipeline portions should be able to be renovated in one piece. Moreover, the electrical power losses in the cable (7) should be reduced. To this end, the invention suggests that at least one operating appliance (10) that is connected to the cable (7) and the UV light source (6) is arranged at each UV module (3), wherein the control device (9) actuates the operating appliance (10) by way of the cable (7) for the purposes of operating the UV light source (6).

The invention relates to a curing apparatus having at least one UV module, wherein the UV module has at least one UV light source for irradiating the inner wall of a pipe, wherein the UV module that has been introduced into the pipe is connected, by means of a cable, to a control device that is situated outside of the pipe.

For the purposes of renovating pipes that have been laid underground, the prior art has disclosed the practice of pulling a so-called liner into the respective pipe. The liner is a hose consisting of a fiber material that is soaked with a resin that is curable by UV light. After being pulled into the pipe, the liner is pressed against the inner wall of the pipe by means of compressed air. Thereupon, the resin of the conductor is cured by virtue of use being made of a curing apparatus. The curing apparatus has a plurality of UV modules that are coupled to one another, each of which being equipped with at least one UV light source. The chain of UV modules is guided through the pipe that has been lined with the liner. The UV light emitted by the UV light sources of the UV modules irradiates the inner wall of the pipe, as a result of which the resin is cured. Depending on the pipe diameter, UV light sources with different powers are used.

In the known curing apparatuses (see DE 20 2005 020 431 U1, for example), the UV modules introduced into the pipe are connected by way of a cable to a control device (usually in the form of a control cabinet) situated outside of the pipe, i.e. above ground. Here, an operating appliance specifically tuned to the UV light source is assigned to each UV light source, said operating appliance being installed in the control device. Usually, the UV light sources are discharge lamps (e.g. mercury vapor lamps). The operating appliances are configured to ignite the discharge lamps and, after ignition, to control the operating current of the discharge lamps. Since an operating appliance must be assigned one-to-one to each UV light source that is situated in the pipe, the cable connecting the control device to the UV modules comprises a multiplicity of wires as power supply lines of the individual UV light sources. A high operating current flows through the high-power UV light sources. Accordingly, the wires of the cable must have a large cross section. It is for this reason that the cable overall has a very large cross section. A disadvantage emerging therefrom is that the cable length, and hence the length of a respective pipeline portion that can be renovated in one piece, is restricted. However, for reasons of efficiency, and hence costs, it is desirable to be able to renovate pipeline portions that are as long as possible in one piece. A further disadvantage of the curing apparatuses known from the prior art is that very high power losses in the cable arise on account of the high currents flowing through the power supply lines of the cable.

Against this background, it is an object of the invention to provide a curing apparatus in which the cable for connecting the UV modules to the control device may have a reduced cross section in relation to the prior art. As a result, longer pipeline portions should be able to be renovated in one piece. Moreover, the electrical power losses in the cable should be reduced.

Proceeding from a curing apparatus of the type set forth at the outset, this object is achieved by the invention by virtue of at least one operating appliance that is connected to the cable and the UV light source being arranged at each UV module, wherein the control device actuates the operating appliance by way of the cable for the purposes of operating the UV light source.

The peculiarity of the curing apparatus according to the invention consists of the operating appliance assigned to the respective UV light source being situated directly at the UV module, i.e. in the pipe to be renovated, and hence in the immediate surroundings of the UV light source. Therefore, there is no need to bridge long line portions between the operating appliance and the UV light source. Compared to the prior art, the cable for connecting the UV modules to the control device situated outside of the pipe requires fewer wires as power supply lines, to which the individual operating appliances are connected. The power supply lines can be operated at a higher voltage, e.g. at mains voltage. Accordingly, the power losses are reduced. Consequently, the individual wires of the cable may have a smaller cross section. Overall, it is consequently possible to significantly reduce the cross section of the cable in relation to the prior art. The cable that is transported to a building site/to a pipe to be renovated on a cable drum by means of a vehicle, for example, can be correspondingly longer. In practice, the invention facilitates cable lengths of 500 m or more.

Preferably, the operating appliance of the curing apparatus according to the invention has an ignition device for igniting the UV light source that is embodied as a discharge lamp. The ignition device produces a sufficiently high voltage, and so the discharge lamp ignites.

Furthermore, the operating appliance expediently has a power supply circuit in order to control and/or regulate the operating current of the UV light source, i.e. after the discharge lamp has ignited, according to the design of the discharge lamp and according to the desired UV power.

In a preferred configuration, the cable which connects the UV modules to the control device situated outside of the pipe has not only two or more wires as a power supply line, as mentioned previously, but, additionally, two or more wires as a data line. Then, two or more operating appliances of the curing apparatus, i.e. the operating appliances of the individual UV modules and UV light sources, can be respectively connected in parallel to the power supply line and the data line. This means that a plurality of operating appliances are connected to the same wires of the power supply line and the data line. Accordingly, a smaller number of wires is required in comparison with the prior art.

The data line is used to actuate the operating appliances of the curing apparatus according to the invention. A data bus can be realized in a manner known per se by way of the data line. By way of the data line, there is a bidirectional communication between the control device and the operating appliances, and so the UV light sources can be actuated and monitored on an individual basis. To this end, the operating appliances may each have a serial data interface, preferably an RS485 interface, for example, which uses the wires of the data line for data transmission between the operating appliance and the control device.

In a preferred configuration, the operating appliance of each UV light source has an input-side rectifier that is connected to the power supply line, and an inverter that is connected to the rectifier and actuated by a microcontroller, said inverter being connected on the output side to the UV light source. In this configuration, the operating appliance has a structure similar to that of a switched-mode power supply. From the mains voltage applied to the power supply line, it produces the voltage required for operating the respective UV light source and regulates the operating current of the UV light source. The operating current is regulated by means of the microcontroller which, to this end, actuates the inverter in a suitable manner. The operating current is controlled by frequency variation and/or pulse width modulation.

In a preferred configuration, the inverter of the operating appliance is connected, on the output side, to a voltage overshoot circuit, the latter producing at the terminals of the UV light source an ignition voltage that has overshot an operating voltage of the UV light source, depending on the frequency of the output voltage of the inverter. For the purposes of igniting the discharge lamps that are usually used as UV light sources, it is necessary to produce an ignition voltage in the kilovolt range. This is possible, for example by virtue of connecting a resonant circuit consisting of a choke and a capacitor to the inverter at the output side. By way of suitably controlling the frequency of the inverter, the resonant circuit is operated in the vicinity of its resonant frequency, and so there is a correspondingly high voltage drop in the resonant circuit, which suffices for igniting the discharge lamp.

Further, the operating appliances of the curing apparatus according to the invention expediently have a current measuring device that is connected to, or integrated in, the microcontroller, said current measuring device measuring the current flowing through the UV light source. This allows regulation of the operating current by means of the microcontroller.

In a preferred configuration of the curing apparatus according to the invention, the cable, which connects the UV modules to the control device situated outside of the pipe, is embodied as a pull cable, by means of which a plurality of similar UV modules that are strung in succession and coupled to one another are movable through the pipe. The UV modules that are coupled to one another are pulled slowly through the pipe by means of the cable. In the process, the resin-soaked liner is cured lengthwise in the movement direction of the UV modules.

In a further preferred configuration of the curing apparatus according to the invention, each UV module has one or more temperature detectors that are connected to, or integrated in, the operating appliance. By way of example, the temperature detectors can be infrared sensors which measure the surface temperature at the inner wall of the pipe.

The artificial resin with which the liner is soaked is cured by polymerization triggered by the UV radiation. The polymerization is an exothermic reaction, in which heat is released, leading to a temperature increase at the inner wall of the pipe. The temperature increase must not be too strong as this could lead to overheating. The material of the liner, or even the material of the pipe, could melt. In certain circumstances, there is also the risk of a fire. Overheating occurs if the UV modules are pulled too slowly through the pipe. Then, the polymerization is performed too quickly on account of the high UV intensity. On the other hand, if the UV modules are pulled too quickly through the pipe, the UV intensity does not suffice to bring about a complete polymerization. Then, the curing is incomplete. Incomplete curing can be identified by virtue of the surface temperature on the inner wall of the pipe having an increase that is too weak.

The temperature detectors connected to, or integrated in, the operating appliance can be used, according to the invention, to ascertain the ideal movement speed of the UV modules within the pipe. The temperature detectors assigned to the UV modules arranged in succession can be used to record a temperature profile on the inner wall of the pipe in the movement direction of the UV modules. This temperature profile provides information about the progress of the polymerization reaction and can therefore be used to control the ideal movement speed of the UV modules (see DE 198 17 413 C2). Here, the measured surface temperatures are expediently transferred to the control device, situated outside of the pipe, of the curing apparatus according to the invention via the data interfaces of the operating appliances. The control device evaluates the temperature data and the operator ascertains the ideal movement speed therefrom. Optionally, it is also possible to realize an automatic regulation of the movement speed.

Furthermore, the temperature detectors of the UV modules can be used to ascertain the ambient temperature in the pipe. The UV light sources and the electronic components of the associated operating appliances are designed for certain temperature ranges. By measuring the ambient temperature, it is possible to determine that the curing apparatus is operated within the admissible temperature range.

The operating appliances of the curing apparatus according to the invention can be configured to capture further parameters, such as the lamp voltages of the discharge lamps. As a result, it is possible to determine whether the discharge lamps are still in order or have to be replaced because they have reached the end of their service life. Photosensors can be used to measure the produced UV light intensity. Additionally, it is possible to capture the lamp currents of the discharge lamps, system temperatures, air temperatures, temperature profiles, spatial orientation (including longitudinal and transverse tilt) and the position of the respective UV module by means of suitable sensors and communicate the appropriate data via the data line. All this data can be used for the purposes of quality assurance within the scope of renovating pipes.

Exemplary embodiments of the invention will be explained in more detail on the basis of the drawings. In the drawings:

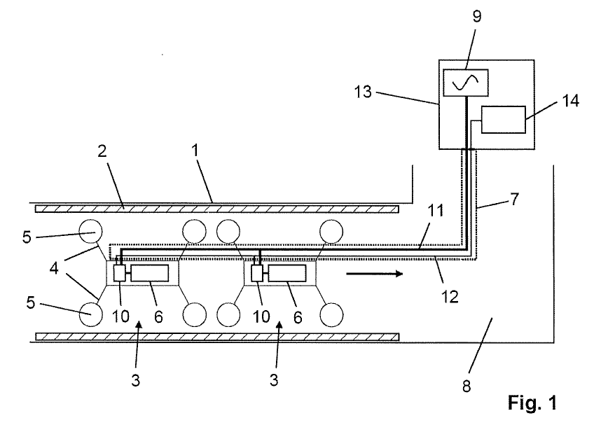

FIG. 1: shows a schematic illustration of a curing apparatus according to the invention;

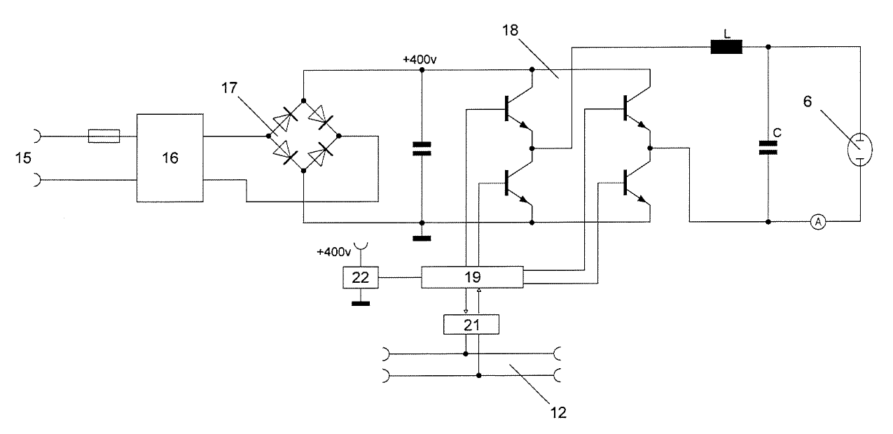

FIG. 2: shows a sketched circuit diagram of an operating appliance according to the invention in a first configuration; and

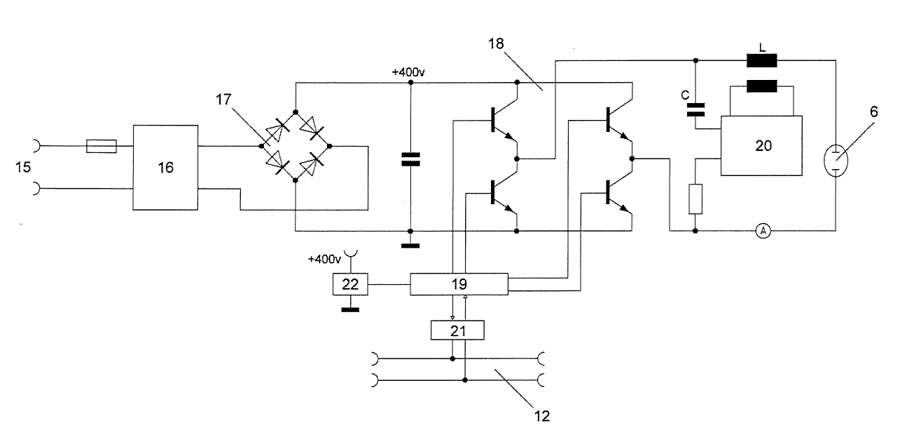

FIG. 3: shows a sketched circuit diagram of an operating appliance according to the invention in a second configuration.

FIG. 1 schematically shows a curing apparatus according to the invention. A pipe 1 laid underground should be renovated. To this end, a liner 2 is pulled into the pipe and expanded with the aid of compressed air and said liner rests against the inner wall of the pipe 1. The liner 2 is soaked with resin that is curable by way of irradiation with UV light.

The curing apparatus according to the invention is used for curing the artificial resin. Said curing apparatus comprises, as illustrated in FIG. 1, a plurality of UV modules 3 that are coupled to one another in a hinged fashion, wherein each UV module 3 has, arranged on spring-mounted arms 4, wheels or sliding runners 5 that serve to guide the modules 3 within the pipe 2 and allow an adaptation to different pipe diameters.

Each UV module 3 has a UV light source 6, which is a discharge lamp (e.g. mercury vapor lamp) with a conventional design. In the illustrated exemplary embodiment, each UV module 3 has exactly one UV light source 6. However, depending on the application, it is also possible for a plurality of UV light sources 6 to be provided for each UV module 3. By way of example, in order to irradiate the inner wall of the pipe 2, a plurality of UV light sources 6 may be arranged on a UV module 3 with a uniform distribution about the circumference thereof.

The UV modules 3 introduced into the pipe 2 are connected to a control device 9 situated outside of the pipe 2 by way of a common cable 7, which is guided through the pipe 2 and out of the pipe and to the surface of the ground through an inspection shaft 8.

According to the invention, each UV module 3 has at least one operating appliance 10, which is assigned to the corresponding UV light source 6. In each case, the operating appliance 10 serves for ignition purposes and for regulating the operating current of the UV light source 6. Each operating appliance 10 is connected to the control device 9 via the cable 7. The control device 9 actuates the operating appliances 10 of the individual UV light sources 6 by way of the cable 7. For the purposes of supplying the UV light sources 6 with power, the cable 7 comprises two or more wires that form a power supply line 11. Furthermore, the cable 7 comprises two or more wires that form a data line 12. It is clear from FIG. 1 that the operating appliances 10 are connected in parallel to the power supply line 11 and the data line 12. In the control device 9, the power supply line 11 is connected to a mains connector 13, and so the UV light sources 6 are appropriately supplied with energy by way of the operating appliances 10. The data line 12 is connected to a microcomputer 14 of the control device 9. The operating appliances 10 communicate in bidirectional fashion with the microcomputer 14 via the data line 12. By way of the data line 12, the microcomputer 14 controls the ignition of the UV light sources 6 and monitors the operational parameters thereof. Moreover, measurement data of optionally provided sensors (e.g. temperature sensors) of the UV modules 3 are transmitted via the data line 12 to the microcomputer 14, where they are suitably processed further.

FIGS. 2 and 3 show sketched circuit diagrams of possible embodiments of the operating appliances 10 illustrated in FIG. 1. The operating appliance 10 is connected to the power supply line 11, i.e. to the power grid, by way of terminals 15. The mains voltage is filtered by means of a mains filter 16 and then converted into DC voltage by means of a rectifier 17. The rectifier 17 is connected to an inverter 18 that is disposed downstream thereof and respectively realized by an H-bridge circuit with four field-effect transistors in the illustrated exemplary embodiments. At the outputs of the bridge circuit, the inverter 18 is connected to the discharge lamp that forms the UV light source 6. The field-effect transistors of the inverter 18 are actuated by a microcontroller 19 of the operating appliance 10 in order to control or regulate the operating voltage and the operating current of the UV light source 6 by way of controlling the frequency at which the inverter 18 is operated and/or by way of pulse width modulation. For the purposes of igniting the UV light source 6, a voltage overshoot circuit in the form of a resonant circuit is provided as an ignition device in FIG. 2, said resonant circuit being formed by a choke L and a capacitor C. For the purposes of ignition, the inverter 18 is actuated in such a way that the choke L and the capacitor C are in resonance. The voltage drop over the capacitor C in the process suffices for igniting the UV light source 6. Deviating therefrom, the choke L contains a second winding in the exemplary embodiment illustrated in FIG. 3. A voltage doubling circuit 20 charges the ignition capacitor C by means of the applied AC voltage. When the DC voltage at the ignition capacitor C exceeds the ignition voltage of a spark gap contained in the voltage doubling circuit, the latter ignites and discharges the capacitor C in impulsive fashion by way of the second winding of the choke L. The high voltage in the choke L arising thereby ignites the UV light source 6. After ignition, the frequency of the inverter 18 is modified by means of the microcontroller 19 and the operating current is regulated to a desired setpoint value. To this end, a current measuring device A that is connected to the microcontroller 19 is provided in the circuit of the UV light source 6. For initiating the ignition process, for predetermining the setpoint value of the operating current and for transmitting the other data arising in the operating appliance 10 (temperature, operating current, operating voltage of the UV light source 6, etc.), the microcontroller 19 is connected via a data interface 21 (e.g. an RS485 interface) to the wires of the data line 12. For the purposes of supplying the microcontroller 19 with power, provision is made of a power supply circuit 22 that is operated with rectified mains voltage.

According to the invention, the operating appliances 10 consequently control the operating current regulation and the ignition of the respective discharge lamps that are used as UV light sources 6. The operating appliances 10 are placed directly at the respective UV light source 6 within the associated UV module 3. A plurality of operating appliances can be connected in parallel to the wires of the cable 7. What emerges therefrom is that the cable 7 may have a smaller number of wires with, moreover, a smaller cross section in relation to the prior art. Consequently, the cable 7 overall can have a significantly reduced cross section in relation to the prior art. The result of this is that a cable drum, which is usually used in pipe renovation work, can receive a substantially longer cable 7. Accordingly, it is possible to renovate longer pipeline portions in one piece. Moreover, the line losses in relation to the prior art are lower on account of the higher voltages on the wires of the power supply line of the cable 7.

1. A curing apparatus having at least one UV module, wherein the UV module has at least one UV light source for irradiating the inner wall of a pipe, wherein the UV module that has been introduced into the pipe is connected, by means of a cable, to a control device that is situated outside of the pipe,
wherein each UV module has at least one operating appliance that is connected to the cable and the UV light source, wherein the control device actuates the operating appliance by way of the cable for the purposes of operating the UV light source.

2. The curing apparatus as claimed in claim 1, wherein the operating appliance has an ignition device for igniting the UV light source that is embodied as a discharge lamp.

3. The curing apparatus as claimed in claim 1, wherein the operating appliance has a power supply circuit which controls or regulates the operating current of the UV light source.

4. The curing apparatus as claimed in claim 1, wherein the cable has two or more wires as a power supply line and two or more further wires as a data line.

5. The curing apparatus as claimed in claim 4, wherein two or more operating appliances are connected in parallel with the wires of the power supply line and the wires of the data line.

6. The curing apparatus as claimed in claim 4 wherein the operating appliance has a serial data interface, preferably an RS 485 interface, which uses the wires of the data line for data transfer between the operating appliance and the control device.

7. The curing apparatus as claimed claim 4, wherein the operating appliance has an input-side rectifier that is connected to the power supply line, and an inverter that is connected to the rectifier and actuated by microcontroller, said inverter being connected on the output side to the UV light source.

8. The curing apparatus as claimed in claim 7, wherein the inverter is connected, on the output side, to a voltage overshoot circuit (L, C), the latter producing at the input of the UV light source an ignition voltage that has overshot an operating voltage of the UV light source, depending on the frequency of the output voltage of the inverter.

9. The curing apparatus as claimed in claim 7, wherein the inverter is connected, on the output side, to a voltage overshoot circuit that, by way of an impulsive discharge of a capacitor (C) via an additional winding of a choke (L) connected on the output side to the inverter, produces an ignition voltage that has overshot an operating voltage of the UV light source at the UV light source.

10. The curing apparatus as claimed in claim 7, wherein the operating appliance has a current measuring device (A) that is connected to, or integrated in, the microcontroller, said current measuring device measuring the current flowing through the UV light source.

11. The curing apparatus as claimed in claim 1, wherein the cable is embodied as a pull cable, by means of which a plurality of similar UV modules that are strung in succession and coupled to one another are movable through the pipe.

12. The curing apparatus as claimed in claim 1, wherein each UV module has one or more temperature detectors that are connected to, or integrated in, the operating appliance.

13. The curing apparatus as claimed in claim 12, wherein the temperature detectors measure the surface temperature of the inner wall of the pipe.

14. The curing apparatus as claimed in claim 1, wherein the operating appliance has further sensors that are connected to, or integrated in, the microcontroller, to be precise a photosensor for measuring the produced UV light intensity, a temperature sensor for measuring the system temperature of the respective UV module or the air temperature in the surroundings of the UV module, a spatial orientation sensor for capturing the longitudinal or transverse tilt of at least one of the UV module, and a position sensor for capturing the position of the respective UV module in the pipe.
